(19) United States
(12) Patent Application Publication
(10) Pub. No.: US 2009/0298027 A1
(43) Pub. Date: Dec. 3, 2009

(54) PERSONALITY PROFILE ANALYTICAL TOOL

(76) Inventor: Brook Thornley, Syracuse, UT (US)

Correspondence Address: Workman Nydegger;1000 Eagle Gate Tower, 60 East South Temple, Salt Lake City, UT, 84111, US

(21) Appl. No.: 12/481,381

(22) Filed: Jun. 9, 2009

Related U.S. Application Data
(63) Continuation of application No. 11/209,324, filed on Aug. 23, 2005, now abandoned.
(60) Provisional application No. 60/605,535, filed on Aug. 27, 2004.

(51) Int. Cl. G09B 19/00

(52) U.S. Cl. 434/236

(57) ABSTRACT

A method of analyzing a person's personality profile is in accordance with the present invention. The method includes the following: (a) analyzing a first element to determine a first primary attribute for the person, wherein the first primary attribute is characterized as being an attribute that is predominant with respect to the first element, and the attribute is selected from the group consisting of saturated, whitened, grayed, and blackened; (b) analyzing at least a second element to determine at least a second primary attribute for the person, wherein the at least second primary attribute is characterized as being the attribute that is predominant with respect to the first element; (c) correlating the first primary attribute with the at least second primary attribute to obtain a correlated primary attribute; and (d) identifying personality characteristics related to the correlated primary attribute.

### CROSS-REFERENCE TO RELATED APPLICATIONS

This application is a continuation application of U.S. patent application Ser. No. 11/209,324, filed Aug. 23, 2005, entitled PERSONALITY PROFILE ANALYTICAL TOOL, which claims the benefit of U.S. Provisional Patent Application No. 60/605,535, filed Aug. 27, 2004, entitled, METHOD AND PROCESS OF INDIVIDUAL DIAGNOSIS OF DESIGN PROFILE, each of which is incorporated herein by reference.

### BACKGROUND OF THE INVENTION

1. The Field of the Invention

The present invention relates to methods and processes for assessing and analyzing the personality of a person. More particularly, the present invention relates to methods of cross-referencing physical features displayed by a person to determine a personality profile or predisposition that can be used for improving the aesthetics of the person and for tailoring interpersonal interactions with the person.

2. The Related Technology

The ability of colors to affect a person's mood or disposition has been known for years, but continues to be explored. For example, blue has been associated with sadness, red has been associated with anger, and yellow has been associated with cheerfulness. Recently, there have been a lot of studies looking more deeply into how various colors can affect a person's mood or disposition. The results of various studies have presented ideologies that range from the colors a person should wear to the colors a person's personality is associated with. While colors have been matched to personality types, moods, and visual aesthetics, there has yet to be a satisfying correlation between them.

Some of the current tests that assess or predict a person's personality, mood, or disposition are implemented by requesting certain selections to be made from prepared lists of questions. For example, one personality test based on color requests the person being analyzed to select all of the presented colors in order based on their feeling. The analysis then uses the color selection to prepare a summary of the person's personality and disposition. Another test requests the person being analyzed to make a number of selections of self-assessing statements from a prepared list. A personality color and explanation is then provided. Still another test requests the person being analyzed to rank a series of word groupings, which then results in a personality color profile to be generated.

The foregoing tests that purport to correlate a person's personality or disposition with colors are not an exhaustive list. However, all of these tests, as well as others, receive information about the person via answering questions or prearranged selection forms. As such, the person can modify the results by changing their answers. Accordingly, the personality profile and/or related colors can be modified by the daily whim or otherwise changing a selection or answer. While it is apparent that colors do have important influence of personality, mood, and/or behavior, the current correlating analyses do not provide consistent and reproducible results based on objective standards.

Therefore, it would be advantageous to have a personality profile analytical tool that does not base an analysis and/or result on questions that can be subjectively answered. Additionally, it would be beneficial to have a personality profile analytical tool that cross-references various physical traits that can be empirically assessed. Furthermore, it would be beneficial to have a personality profile analytical tool that can be based on factors other than or in addition to color.

### BRIEF SUMMARY OF THE INVENTION

Generally, an embodiment of the present invention includes a method of analyzing a person's personality profile. Such a method includes the following: (a) analyzing a first element to determine a first primary attribute for the person, wherein the first primary attribute is characterized as being an attribute that is predominant with respect to the first element, and the attribute is selected from the group consisting of saturated, whitened, grayed, and blackened; (b) analyzing at least a second element to determine at least a second primary attribute for the person, wherein the at least second primary attribute is characterized as being the attribute that is predominant with respect to the second element; (c) correlating the first primary attribute with the at least second primary attribute to obtain a correlated primary attribute; and (d) identifying personality characteristics related to the correlated primary attribute.

In one embodiment, the present invention includes a method of analyzing a person's personality profile that can be based on observable elements. The method can include the following: (a) selecting a first element and second element of a person to analyze with respect to having at least one attribute selected from the group comprised of saturated, whitened, grayed, and blackened, the first and second elements being selected from the group comprised of color, lines, movement, sound, and texture; (b) analyzing the first element and second element for the presence of the at least one attribute; (c) determining a primary attribute that is the same for the first element and second element; and (d) identifying a personality characteristics that correspond with the primary attribute.

In one embodiment, a method of analyzing a person's personality profile can be based on the person's physical features. The method can include the following: (a) analyzing a color element and a line element for the presence of at least one attribute selected from the group comprised of saturated, whitened, grayed, and blackened; (b) determining a primary attribute for the color element and line element, wherein the primary attribute is the most predominant attribute for both the color element and the line element; and (c) identifying a personality characteristic that corresponds with the primary attribute.

These and other embodiments and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a flow diagram that illustrates an embodiment of a method for assessing whether a color element has a saturated attribute;

FIG. 1B is a flow diagram that illustrates an embodiment of a method for assessing whether a color element has a whitened attribute;

FIG. 1C is a flow diagram that illustrates an embodiment of a method for assessing whether a color element has a grayed attribute;

FIG. 1D is a flow diagram that illustrates an embodiment of a method for assessing whether a color element has a blackened attribute;

FIG. 2A is a flow diagram that illustrates an embodiment of a method for assessing whether an element of a person has a saturated attribute;

FIG. 2B is a flow diagram that illustrates an embodiment of a method for assessing whether an element of a person has a whitened attribute;

FIG. 2C is a flow diagram that illustrates an embodiment of a method for assessing whether an element of a person has a grayed attribute;

FIG. 2D is a flow diagram that illustrates an embodiment of a method for assessing whether an element of a person has a blackened attribute;

FIG. 3A is a flow diagram that illustrates an embodiment of a method for performing a design analysis;

FIG. 3B is a flow diagram that illustrates an embodiment of a method for performing a design analysis;

FIG. 3C is a flow diagram that illustrates an embodiment of a method for performing a design analysis;

FIG. 4 is a flow diagram that illustrates an embodiment of a method for assembling a color fan for the person's color attribute;

FIG. 5 is a flow diagram that illustrates an embodiment of a method for performing a personality profile analysis;

FIG. 6 is a flow diagram that illustrates an embodiment of a method for identifying a person's projecting color;

FIG. 7 is a flow diagram that illustrates an embodiment of a method for performing a personality profile analysis; and

FIG. 8 is a flow diagram that illustrates an embodiment of a method for interacting with a person based on an analysis of their personality profile.

### DETAILED DESCRIPTION OF THE PREFERRED EMBODIMENTS

Generally, the present invention is related to the analysis of the organization of a person's physical characteristics and features in order to assess their personality profile and predispositions. That is, by analyzing the physical attributes a person displays, their underlying behavioral tendencies and interpersonal mannerisms can be identified and/or predicted. In one aspect, this can be performed by assessing different elements of a person's physical features to determine the presence of a certain attributes. As such, the element is compared with different attributes for the element to determine whether or not a certain attribute is present, and/or which attribute is most dominant. After the primary attributes are identified for more than one element, such primary attributes are compared and correlated to determine whether each element has the same primary attribute. In the instance that multiple elements have the same primary attribute, the person's personality profile can be properly determined. This is because it has been found that corresponding primary attributes for multiple elements is indicative of the person's personality and predispositions. This correlation can be considered to be a phenomenon of the harmony between the primary attribute for each element, which is interrelated to a person's personality profile or predisposition.

An overall harmonious correlation between physical elements or features with personality profiles or predispositions can be identified by observing various physical elements of a person's design. A person's design can be defined to be the approximate percentage of the established attributes that are present in each of the observable physical elements. As such, a person's design arises from the harmony between the attributes for different elements, which can be measured and cross referenced through principals arising from basic design elements. The basic design elements are physical features, such as color, lines, texture, movement, and sound, which are cross referenced in order to determine the presence of a harmonious interrelationship between them.

Then main physical elements, which can be considered to be the basic design elements, include a person's color, line, sound, and movement. Additionally, a person's texture can also be assessed as a basic design element. Thus, these basic design elements can be observed and analyzed in order to determine the attributes for each element, as well as the predominant attribute that is consistent between the different elements. The attributes, which are terms based on the quality of different colors, include saturated, whitened, grayed, and blackened. While the attributes appear to describe the amount of hue, tint, tone, and shading a particular color may include, the terms used for the attributes also relate to the various lines, movements, textures, and sounds, which is discussed in more detail below.

Previously, there has not been a method of correlating the harmonious relationship between the basic design elements. In part, this is because there has not been an organized and consistent protocol to utilize for measuring the primary attribute for each element in the individual's overall design. The combination and relative amounts of each attribute that describes each and every element are considered to define the person's overall design. Thus, the present invention provides a method of observing and analyzing the basic design elements with respect to the attributes that make up a person's overall design in order assess their predisposition to certain personality and/or behavioral patterns.

### I. Basic Design Elements

The basic design elements are the color, line, sound, and movement that a person displays by their physical features and actions. More particularly, a person's basic design elements can be described as follows: (a) color can be generally described to be the visibly distinct coloring in their completion; (b) line can be generally described as the combination of different lines that define the shape of various features on the person's face, body, and general silhouette; (c) sound can be generally described by the way a person speaks or the quality of the sounds that they vocally emit; and (d) movement is generally described as the motions a person's body undergoes during any action as well as the tendency for their body to be positioned in certain orientations. As such, the color, line, sound, and movements can be observed and analyzed in order to determine which attributes correspond between the different elements.

One of the primary discoveries which make personality profiling possible from observing a person's physical elements, which appear to be truly unique, is the concept that the attributes (e.g., color, line, movement, and sound) correlate consistently across all species and in the surrounding environment. For example, the various design harmonies presented herein can be validated in the color, lines, movement, and sounds as seen in various landscapes, in plant life, or in the animal kingdom. Since the concepts behind the ability to predict personality profiles or predispositions are consistent across all physical dimensions, the concepts and the methodologies of the present invention provide a stable system and process to identify the appropriate color, lines, movements, and sounds in order to identify a person's individual design elements. The correlation between the combinations of attributes for each element, what is referred to herein as “design elements”, is known as a “design harmony.” When each element is precisely measured with respect to the presence of the various attributes, and combined in an appropriate manner, the design harmony is achieved, which is indicative of a particular personality profile or predisposition.

### A. Element of Color

One of the primary design elements includes the analysis of the color of a person's complexion. The principles involved in the analysis of color include comparing some or all of the colors of a color fan, and identifying the particular color configuration that is harmonious and matches with a person's skin color. That is, the color has a specific percentage of each attribute and matches the person's skin coloring. Such a percentage of each attribute can be considered to at least partially define the person's design color or harmony color. Actually, the design color or harmony color is typically used to identify the amount of each attribute, but also refers to any color with the same percentage of the attributes or attribute ratio. Accordingly, a design color can be any of red, blue, green, yellow, and the like that include substantially the same percentage of the attributes or attribute ratio. In any event, the attribute ratio or design color indicates the color(s) that will aid in helping the person look good and feel good.

As before, the design color, which is described by the attribute ratio, can be Mused to identify the person's personality profile or predisposition. Additionally, the design color can be used to decorate the person's attire and/or surrounding in order to provide an atmosphere that is more appealing and comfortable for the person. To this end, when a person is surrounded by their design color, they usually feel more satiated and calmed because of the harmony they have with their environment.

In the process of determining the colors that correspond with a personality profile or preposition, it may be beneficial to start with a color wheel or series of color wheels that can be used to identify the person's design color(s). This can aid in providing or identifying an ambiance or atmosphere that correlates with their harmonious design, and thus is representative of their personality and/or predispositions. For example, a harmonious ambiance or atmosphere that relates to a person having a predominantly saturated color attribute can be portrayed by a simply, precise, and/or contemporary color scheme that includes saturated colors. Saturated colors are described to be the pure chroma for each color on a color wheel, which does not have any tint, tone, or shading. More particularly, the color(s) would be the pure chroma with nothing else added to them. Color wheels that display pure chromo are well known in the art.

Additionally, a harmonious ambiance that is representative of a person with a predominantly whitened color attribute can be identified to be portrayed by an animated or lively color scheme that includes tinted colors. As such, the whitened color scheme includes colors that are tinted by having white stirred into the saturated color wheel. By adding white to a pure chroma, the color becomes more animated, lively, fun and youthful.

A harmonious ambiance that is representative of a person with a predominantly grayed color attribute can be portrayed by an elegant or refined color scheme that includes toned colors. As such, the grayed color scheme includes colors that have gray stirred into the saturated color wheel. This is because the gray toning mutes the pure color and adds elegance and mystique.

Further, a harmonious ambiance that is representative for a person with a predominantly blackened color attribute can be portrayed by a rich, rustic, and/or natural feeling color scheme that includes shaded colors. As such, the blackened color scheme includes colors that have black stirred into the saturated color wheel. This is because the blackening of the pure chromo provides for shades that are indicative of rich, rustic or directness.

### B. Element of Lines

An additional primary design element includes the lines of a person's physical features. The principles involved in the analysis of lines are different from color in that the different types of lines and/or the shapes they construct are analyzed to determine the types of lines and/or shapes that are predominant. The predominant lines and/or shapes are then correlated to attributes. Where colors having varying attributes are compared to a person's complexion, an analysis of the person's lines is performed by identifying the person's type of lines and/or shapes and then determining which attribute they are most closely related.

Accordingly, different types of lines and/or shapes have been correlated to the attributes that describe the design colors. That is, each attribute includes a predefined set of representative lines that correlate with the corresponding color attributes. As such, an analysis of a person's lines can be performed to obtain a percentage or quantification of the lines associated with each attribute. Thus, the attributes of the lines can then be used in much the same way the color attributes are mused, which includes identifying a person's design lines. The design lines indicate the types of lines and/or shapes that can be used in decorations, furniture, clothes, patterns, and the like in order aid in helping the person look good and feel good.

For example, a harmonious ambiance or atmosphere that relates to a person having a predominantly saturated line attribute can be identified by lines that portray stillness, precision, and/or a contemporary look. Saturated line attributes include lines that are long-oval, fast diagonal, or parallel lines. Additionally, the combination of the saturated line and saturated color creates a saturated harmony. A harmonious ambiance representative of a person with a predominantly whitened line attribute can be portrayed by an animated or lively line scheme that includes circles, rounded lines, and other lines that appear bouncy. A harmonious ambiance representative of a person with a predominantly grayed line attribute can be portrayed by an elegant or refined line scheme that includes elongated “S” curves or elongated interconnected arches. A harmonious ambiance representative of a person with a predominantly blackened line attribute can be portrayed a rich, rustic, and/or natural feeling line scheme that includes hard lines, angles, and heavy geometric shapes.

### C. Element of Movement

In addition to color and lines, the element of movement is also an important physical element that can be assessed. While movement may not be present in physical features per se, the manner in which a person moves is not only indicative of their design, but the movements are inherently related to their structural features. Also, the way a person moves their limbs, torso, and/or head serves as an indicator for their personality profile or predisposition.

Accordingly, the analysis of movement is more akin to the analysis of lines than to color. That is, the types of movements that a person performs and/or displays are analyzed and then compared to the groups of movements that are associated with each attribute. This can allow a person to obverse a person's movements and then identify the most predominant movement, which is correlated with its attribute.

For example, a person having a predominantly saturated movement attribute can be identified by moving in a manner that portrays stillness, precision, and/or a controlled. As such, saturated movement attributes can be observed when the person moves their limbs, torso, and/or head with controlled precision, and otherwise is still and sleek when not moving. This can be observed when the person sits still and makes controlled movements before again being still. A person having a predominantly whitened movement attribute can be identified as sitting and moving in an animated, busy, and/or bouncy manner. That is, a whitened person tends to be moving or always having some part of their body in motion and cannot sit still for extended periods of time. A person with a predominantly grayed movement attribute can be observed to move with elegant or refined motions that appear graceful, flowing, and languid. Also, while a grayed person may be more capable of sitting still compared to a whitened person, the grayed person portrays a gracefulness not seen in a still saturated person. A person with a predominantly blackened movement attribute can be seen to move with deliberate and purposeful movements. As such, the blackened person appears to know exactly what they are doing, and position and move their bodies with deliberateness.

### D. Element of Sound

The element of sound is also an important physical element that can be observed and assessed in order to identify personality profiles and predispositions. Similar to movements, sound may not be present in physical feature, but it should be recognized that sounds arise from physical actions and can be easily observed by listening to the person. Also, the manner in which a person speaks or communicates is indicative of their design.

Accordingly, the analysis of sound is more akin to the analysis of lines and movement that to color. More particularly, the way a person sounds can be analyzed and then compared to the groups of sound types that are associated with each of the attributes. This can allow for listening to and analyzing the way a person sounds, and then identifying the most predominant type of sound or speech pattern, which is correlated with its attribute.

For example, a person having a predominantly saturated sound attribute can be identified by speaking in a manner that is authoritative, articulate, and stately. A person having a predominantly whitened sound attribute can be identified as sounding or speaking in a manner that appears to be giggly, rapid, and constant. As such, a whitened person typically appears to talk a lot and usually in an excited or happy manner. A person with a predominantly grayed sound attribute can be heard to speak with a small voice that sounds eloquent and reserved. A person with a predominantly blackened sound attribute can be heard to speak loudly and in a rough or raspy texture. Accordingly, a blackened person speaks directly and with assertiveness.

### E. Element of Texture

Texture can also be an element that can be visually assessed in order to determine a person's personality provide or predispositions. This is because a person's texture can be seen by looking at the condition of their skin on their face, arms, and hands. As before, texture is first observed to identify what texture is present, and then the predominant texture is compared with the textures associated with the different attributes. While textures can be a primary indicator, it is usually assessed after at least one of color, lines, movement, and/or sound. However, it is always possible to make an initial texture analysis when a person's physical appearance predominantly presents a particular texture known to be associated with one of the attributes.

For example, a person having a predominantly saturated texture attribute can be identified by a skin texture that appears to be smooth, stiff, and/or shiny. A person having a predominantly whitened texture attribute can be identified by a skin texture that appears to be soft, crisp, and decorated. A person with a predominantly grayed texture attribute can be identified by a skin texture that appears to be limp, billowy, sheer, and matte. A person with a predominantly blackened texture attribute can be identified by having a skin texture that appears to be knobby, thick, dull, and/or rough.

### F. Element of Contrast Value

Additionally, the contrast value of a person's completion is also an element that can be used in order to identify their personality profile or predisposition. Contrast value can best be described to be the amount of contrasting lightness and darkness, and the value of such contrast. High contrast value can be seen in white on black. As with other elements, the contrast value in a person's coloring can be correlated and cross referenced to determine the presence of the attributes. That is, the contrast value of a person's complexion can be used to indicate which attribute their personality is most related to, or to confirm such an attribute. In part, this is because a person's contrast value can be seen by looking at their skin on their face, arms, and hands.

The contrast value is first observed to identify what level of contrast is present, and then the level of contrast is compared with the values associated with the different attributes. While contrast value can be a primary indicator, it is usually assessed after at least one of color, lines, movement, and/or sound. However, it is always possible to make an initial contrast value analysis when a person's complexion dominantly presents a particular contrast value known to be associated with one of the attributes.

For example, a person having a predominantly saturated contrast value attribute can be identified by skin that has the highest amount of contrast. A person having a predominantly whitened contrast value attribute can be identified by skin that has a medium amount of contrast. A person with a predominantly grayed contrast value attribute can be identified by skin that appears to have the lowest amount of contrast. A person with a predominantly blackened contrast value attribute can be identified by having skin that has a high amount of contrast, but which is lower in contrast in comparison with a saturated contrast value.

### G. Element of Visual Features

Another element of a person's physical appearance that can be used to assess a person's personality profile or tendencies is their visual features. That is, the overall attribute that their physical appearance manifests can be used in an analysis as described herein. This is because a person's visual features can be seen by looking at the overall physical characteristics a person has or how their features are represented. While a person's visual features can used be a primary indicator, it is usually assessed after at least one of color, lines, movement, and/or sound. However, it is always possible to make an initial visual feature analysis when their physical appearance predominantly presents a particular class of features known to be associated with one of the attributes.

For example, a person having a predominantly saturated visual feature attribute can be identified by an overall appearance that is described to appear striking, sculptured, serious, and/or polished. A person having a predominantly whitened visual feature attribute can be identified by an overall appearance that is described to appear youthful, animated, cheerful, and/or inviting. A person with a predominantly grayed visual feature attribute can be identified by an overall appearance that is described to appear elegant, delicate, refined, and/or soft. A person with a predominantly blackened visual feature attribute can be identified by an overall appearance that is described to appear rustic, bold, earthy, rugged, and/or tough.

### H. Element of Scale

Another element of a person's physical appearance that can be used to assess a person's personality profile or tendencies is the scale of their features. That is, the overall size or scale of features that is predominant in their physical appearance can be used to identify their tendencies or predispositions. This is because the scale or size of a person's features can be seen by looking at them and assessing whether most of their features are small, medium, or large.

For example, a person having a predominantly saturated scale attribute can be identified by the overall size of their features being large. A person having a predominantly whitened scale attribute can be identified by the overall size of their features being small. A person with a predominantly grayed scale attribute can be identified by the overall size of their features being medium. A person with a predominantly blackened scale attribute can be identified by an overall size of their features being large. Since saturated and blackened people can have similar scaling, other elements can be used to differentiate between them.

### H. Element of Yin/Yang

The words yin and yang are borrowed from the Chinese, and are used herein to describe the overall qualities of body and facial design. Ancient Chinese philosophers wrote that it can be important to define things that are different and define things that are the same. They realized that any quality can be described in relationship to its opposite. As such, a comparison can be made between hot in contrast to cold, dry to wet, light to dark, and/or hard to soft. This theory of opposition or duality can be observed in all things in existence. Also, the yin/yang, at its basis, can be divided into opposites such as day and night, men and women, and/or movement and stillness. Accordingly, things that move and are warm, firm, bold, bright, large, angular, and open are described to be under the yang category. On the other hand, things that are still, cold, yielding, reserved, shadowy, small, rounded, and mysterious are described to be under the category of yin. Also, yang can be found with some yin, and yin can be found with some yang, which illustrates that most things are in some proportion or a combination of both the yin and yang.

An analysis of the yin/yang can be made by determining which category a person's features are most closely related. In an assessment of a person's body structure, the yin can be presented as feminine features, small features, small bones, refined, dainty, fragile, rounded, petite, and/or elongated. On the other hand, the yang can be presented and angular features, broad shoulders, tall, sturdy, athletic, stately, large, clear cut features, and/or being erect. In an assessment of a person's appearance and/or movement, the yin can be presented as being graceful, impulsive, romantic, languid, understated, subtle, methodical, feminine, youthful, delicate, light, quick, natural, and/or fresh. The yang appearance and/or movement can be described as being dynamic energy, vitality, boldness, sensuousness, earthiness, vigorous stride, firm long stride, sophistication, drama, and/or high fashion. The yin coloring can be described by clear skin, fair skin, low value contrast, grey or blue skin tones or undertones, delicate, and/or smooth. The yang coloring can be described by warmness, dark or chestnut hair, red hair undertones, golden hair undertones, olive hair undertones, dark hair with pale skin, and/or blue skin undertones. The yin facial structure can be described as having an overall roundness, rounded cheeks, small dimples, elongated oval face, and/or few marked facial planes. The yang facial structure can be described as having angular facial planes, square jaw, angular cheek bones, oval face shape, sharp profile, and/or chiseled features. The yin eyes can be described as rounded, wide open, small brow, peaked brow, oval eyes, oval brows, and/or delicate eyebrows. The yang eyes can be described as oval, peaked brows, large oval eyes, arched brows, and/or heavy eyebrows. The yin nose can be described as delicate, short, up-turned, straight, and/or refined. The yang nose can be described as long, straight, sharply chiseled, angular, large, and/or flared nostrils. The yin mouth can be described as rounded, bow-like, small, oval, and/or “S” curved. The yang mouth can be described as full, peaked upper lip, even lips, and/or oval shaped.

Additionally, the personality profile or predisposition associated with the yin can be described as being dependent, gentle, tactful, receptive, quick, intuitive, natural, simple and/or naive. On the other hand, the yin personality or predisposition can be described as being self-sufficient, aggressive, decisive, reserved, dominating, analytical sophisticated, experienced, private, and/or dramatic. Accordingly, any of the characteristics of a person can be described in connection with the yin and yang in order to identify which attribute most closely relates to the yin/yang element.

For example, a person having a predominantly saturated yin/yang attribute can be identified as being predominantly associated with the yang. A person having a predominantly whitened yin/yang attribute can be identified as being predominantly associated with the yin. A person with a predominantly grayed yin/yang attribute can be identified as being predominantly associated with the yin. A person with a predominantly blackened yin/yang attribute can be identified as being predominantly associated with the yang. Since the yin is associated with both whitened and grayed and the yang is associated with saturated and blackened, the yin/yang analysis can be used to support the analysis of the other elements.

### II. Personality Profile or Predisposition Elements

As described above, various physical features can be studied and analyzed in order to determine a person's personality profile and/or predisposition. In part, a person's physical features are in harmony with their personality and predisposition. Accordingly, the physical features can be used to predict how a person may behave. While behaviors can be grouped into various categories, personality profiles and/or predispositions can be particularly useful in describing the person when broken down into the categories of personality style, thought process, central focus, and/or negative tendencies. As such, these personality categories can be either predicted based on analyses of the physical elements, or individually assessed by monitoring how the person acts and interacts with others.

### A. Personality Style

An analysis of a person's features can identify which attribute primarily describes their physical elements, which can then be used to predict their personality profile or predisposition. Such a prediction can be confirmed by studying and analyzing the behavior patterns for that person. As such, a person's style of personality can be predicted and/or determined so as to be associated with one of the primary attributes. This can be accomplished because people have a personality style that is harmonious with their physical features. That is, the way a person behaves or acts can be directly correlated from the way they look, move, or sound.

Accordingly, a person with a saturated attribute can be described to have a personality style that is introverted, competent, precise, influential, and/or sophisticated. By being introverted, the saturated person has a psychological tendency to concentrate or be overly interested in themselves or what they are doing. The saturated person can tend to be competent by being capable of performing any action they are involved in, which arises from a desire to get things done properly. Also, they can be precise in knowledge and/or actions, which can be observed from their vast knowledge as well as their ability to do many things correctly. The influential aspect of a saturated person's personality can result from the respect others give them, which may arise from their competence and reputation for doing things the right way. Also, a saturated person can be described as being sophisticated by having acquired worldly knowledge or refinement, which can be manifested in their lack of natural simplicity or naiveté.

A whitened person can be described to have a personality style that is extraverted, social, spontaneous, and/or silly. The extraverted whitened person can be observed to be outgoing and interested in others or in the environment as opposed to or to the exclusion of self. This can be seen in their ease at being in social settings, wherein the whitened person is extremely adept at being social and getting along with others in a group. A whitened person can be described as being spontaneous because the activities in which they are engaged appear to happen or arise without apparent external cause. Also, the whitened person can have a natural inclination or impulse to engage in various activities, which is not a cause of external incitement or constraint. The whitened person is described to be silly because of their humorous personality that appears to be lacking seriousness or responsibility.

A grayed person can be described to have a personality style that is introverted, proper, meticulous, and/or negotiable. The introverted grey person tends to be self-contained, and thinks about how they are and how things relate to them, which may arise from an overly present sense of their own self. Also, the grayed person can be observed to be proper in their mannerisms and actions, which is demonstrated by following rules of etiquette. A grayed person can be described as being meticulous in their attention to details in everything they do, which can range from cleaning the kitchen immediately after cooking to re-reading a passage to ensure that they obtained all the details. This can also be observed in their attention to being extremely careful and precise, or being extremely or excessively concerned with all details. Additionally, a grayed person's personality can be predisposed to being negotiable or not stubborn. By being negotiable, the grayed person is willing to compromise.

A blackened person can be described to have a personality style that is extroverted, direct, practical, informal, and/or assertive. The blackened person is extroverted because of their directness, which is usually manifested in the propensity to become involved in activities that have a goal. As such, the blackened person is direct with their intentions and moves forward to get things accomplished, which can be manifested by getting involved in group activities and taking charge. This can also been seen in their assertiveness because they think they know how or when things should be done and they are quite vocal. As such, their personality profile or predisposition can result in tending to assert their will on others. Also, a blackened person can be described as being practical because they do not need things which are superfluous. If it is not needed or mandatory, the blackened person with do without it. One thing a blackened person can do without is formality because it is viewed as unnecessary and many things can be done without having to be formal. Thus, the blackened person would prefer to dine in jeans rather than a suit.

### B. Thought Process

Additionally, an analysis of a person's physical features can provide insight into their thought process. Accordingly, a prediction of their though process can be confirmed by studying and analyzing the behavior patterns for that person. As such, a person's through process can be predicted and/or determined so as to be associated with one of the primary attributes. This can be accomplished because people can have a thought process that is harmonious with their physical features. That is, the way they tend to think can be directly correlated from the way they look, move, or sound.

A saturated person can be described to be left-brained, logical, decisive, and/or clear-thinking. A left-brain person is thought to be linear, logical, analytical, and unemotional, and the left brain is thought to control functions including number skills, performing learned manual activities, specialization in the written and spoken language, reasoning, memory sequence, and/or scientific comprehension. Accordingly, a saturated person may be described to be a left-brained thinker, which also is described as being logical. Also, a saturated person can be described as having the power to decide and make conclusive decisions, and maintain the firmness of their decisions so as to appear resolute. The saturated person may be described to be a clear thinker because of the way at which they process information, which allows them to focus and not get bogged down or sidetracked.

A whitened person can be described to think in a manner that is non-structured, non-conforming, spontaneous and/or unassuming. By being non-structured, the whitened person can appear to be unorganized because they jump from subject to subject without any indication that they are keeping track of what is happening. This is observed by most to be stereotypical of someone with attention deficit disorder, but feels completely natural to the whitened person. As such, the thinking process of the whitened person does not conform to any logical sequence of topics or events, and can seem to be the anti-thesis of a logical person. Additionally, one aspect of the whitened person that may lead to this thought pattern can be their susceptibility to being spontaneous because they can spontaneously acquire a new subject and move on. Their spontaneity can also be seen in their predisposition to be capable of doing things on a moments notice without having to carefully plan their actions. The whitened person is also unassuming in that they tend to not exhibit pretensions, boastfulness, or ostentation, which can be manifest in their modest thinking.

A grayed person can be described to think in a manner that is intuitive, sensitive, complex, and/or idealistic. A grayed person can be viewed as being intuitive or having a certain amount of instinct that allows them to think about things as if they were already known or had already been outlined. The thought process of a grayed person can be quite complex in that they consider many issues before making a decision. They can entertain complex thought processes because of their need to pay attention to every detail before moving forward. Also, a grayed person can be viewed as being responsive to external conditions or stimulation, and being susceptible to the attitudes, feelings, or circumstances of others. As such, a grayed person cares what other think. The idealistic tendencies of a grayed person can appear to be influenced by ideals that often conflict with practical considerations, which can be viewed by others as being unrealistic and impractical.

### C. Central Focus

In addition to being able to predict or identify a person's personality style and/or thought process, their central focus can also be determined. A central focus can be described to be the central tenet to which a person follows. As such, the central focus can also be an aspect of their personality style and/or thought process. For example, a saturated person's central focus can be described as being precise and competent. A whitened person's central focus can be described as being socially outgoing and a tendency to have fun. A grayed person's central focus can be described as having a complex knowledge of details and an overall ability to enjoy experiences for what they are. A blackened person's central focus can be described as being task oriented and having the insatiable desire to get things done and then move to the next task.

### D. Negative Tendencies

In addition to the foregoing personality profiles and predispositions that can be socially positive, most people possess an innate tendency to behave in a socially negative manner. As such, a person's negative tendencies can also be predicted from being in harmony with their physical elements as well as their thought process and personality style.

A saturated person can have negative tendencies of being uncompromising, intimidating, a perfectionist, aloof, demanding, and intolerant. They are uncompromising because of tendencies to be unwilling to grant concessions or negotiate, and they are extremely inflexible. A saturated person can be intimidating to others because of the attitude and atmosphere they are associated with, but usually not from being threatening. They usually intimidate by being present rather than being forceful. Additionally, the saturated person can be viewed as being a perfectionist because they want to do things or have things done perfectly, which is usually viewed by others as a propensity for being displeased with anything that is not perfect or does not meet extremely high standards. Also, they can be demanding because they know what they want, such as having things done perfectly. A saturated person may appear to be aloof by being emotionally distant from their present situation. Moreover, a saturated person can appear to be intolerant by always wanting to get down to business and not tolerating any sidetracking or anything unnecessary.

A whitened person can have negative tendencies of being non-committal, annoying, intrusive, and inconsiderate. A whitened person can be difficult to make commitments with because of their tendency to refuse to provide a particular opinion or perform a particular course of action. Also, the whitened person can be intrusive into other people's business because they do not have the sense of the privacy others may want or need. The whitened person can also be inconsiderate in that they appear to be thoughtless of others and display a lack of consideration; however, this may be because they just did not consider the feelings of others, or their actions were not carefully thought out or ill-advised. As such, the foregoing negative tendencies a whitened person can display may be a part of the reason they can be annoying to others.

A grayed person can have the negative tendency of being indecisive. While a grayed person can also have other negative tendencies, the most consistent annoyance is usually the inability to make a decision.

A blackened person can have the negative tendencies of being overbearing, abrupt, insensitive, overly-logical, and overly-resourceful. A saturated person can be overbearing in that they have such a dominant personality type that they push their desires onto other people. Accordingly, blackened people can be viewed as being overwhelming in power or significance. Also, a blackened person can be abrupt by making decisions that are unexpectedly sudden, or behave in a manner that is surprisingly curt or brusque. As such, the abruptness and overbearing tendencies can make a blackened person appear to be extremely insensitive by behaving in a manner that lacks sensitivity to the feelings or circumstances of others. A blackened person can be overly-logical by adhering too closely to the forms or rules of logic and not being capable of deviating from a logical plan. Additionally, the blackened person can appear to be overly-resourceful by either knowing where to get something or how to do something, which usually stems from the fact that the blackened person has gone to great lengths to know everything, or so it may seem.

### III. Attributes of the Elements

The elements that make up a person's appearance and/or characteristics can be analyzed in order to identify or postulate the presence of different personality profiles or predispositions. As such, the elements, which can include the foregoing elements as well as others discussed in more detail below, are analyzed so as to determine the presence and amount of each attribute. That is, each element is analyzed to determine the primary attribute or attribute ratio that properly or predominantly characterizes the element. As such, the attributes are described and/or defined to include related descriptive characteristics for each element. Accordingly, a detailed description of each attribute as it relates to the various elements can be used to analyze or assess the elements for identifying which attribute is most closely related to the person being analyzed.

### A. Saturated

The description and possibly the origination of the saturated attributes comes from the color wheel in its pure chroma form. All of the colors on a pure chroma color wheel include each color, such as red, orange, yellow, green, blue, indigo, violet, as well as others, with no other color, tint, tone, or shade added to it. The pure chroma of saturation is often referred to as a pure hue.

A person that is saturated tends to appear more harmonious or comfortable in the presence of any and/or all the colors on a saturated color wheel. Often, when a person is saturated, it can become obvious when the colors of the saturated color wheel are presented next their skin because their personal coloring tends to match or harmonize with all of the colors that are pure and have no other color added to them. Accordingly, as a saturated person is compared to a grouping of colors, which includes saturated colors, it becomes very clear that their coloring harmonizes preferentially with the saturated colors. Also, this usually corresponds with very simple lines and a smooth texture. Often, a saturated person can be visually identified because they tend to be very light skinned with dark hair; however, this is not a strict limitation for being saturated.

Further analysis of a saturated person can often result in identifying the various lines in their body being predominantly straight, parallel, or fast diagonal lines. For reference, the lines tend to appear similar to the expected shape of ornamentation of a contemporary piece or art and/or furniture. Their bone structure is usually consistent with the lines of the saturated attributes. Often, the bones in their face relate to long ovals or are straight like parallel lines. Their fingers can be seen to be the same length all the way down from the tip to knuckle, and the finger appear to be parallel lines.

Additionally, when the saturated person sits and/or moves around, there is not a lot of superfluous motions or movement. As such, for the most part they are still, even when moving. This can be described by a person that keeps a still frame while walking, or sits still without moving or extended durations. The saturated person cues others into their saturation and actually communicates their disposition by portraying stillness so that it can be recognized that they are fine piece or natural art that is simple, but yet is representative of something of high quality.

Saturation also relates to the personality profile or predisposition of someone having saturation as their primary attribute. The central focus for a saturated person can be regarded as being competent and accurate, and often are passive in taking charge of situations. A saturated person can be predisposed to walk tall and erect, and speak very properly so as to communicate very clearly. They can feel self-conscious when they intimidate people, and see this as a negative aspect of their persona. Sometimes they attempt to be more approachable, but find themselves not effective and appearing aloof. Also, the saturated person can internally believe they are on this earth to take charge of the situations they are involved in; however, this is sometimes conflicts with the fact that they usually do not want to make a scene or appear dominant. This is the aspect of their character that passively takes charge and, yet allows others to be viewed as leaders. Also, saturated people tend to be recognized as being clear thinkers. Additionally, they tend to be organizers and perfectionists without actually being actually organized or perfect.

For example, the predisposition of a saturated person can be described by someone that prefers to be greeted in a simple manner and in a diplomatic tone. This can be exemplified by a saturated person preferring a short and simple greeting, such as “good morning,” without anything else. This is because they prefer to be recognized without having a lot of attention drawn to them.

In summary, the saturated person can analyzed with the characteristics, both physical and/or personality, as shown in Table 1.

TABLE 1
Saturated

| | |
|---|---|
| Color: | Pure chroma |
| Lines: | Oval and straight body shapes, parallel lines, and/or fast |
| | diagonals |
| Contrast Value: | High |
| Visual Features: | Striking, sculptured, dramatic, serious, regal, and/or polished |
| Sound: | Authoritative, clear articulate words, stately, and/or advanced |
| | vocabulary |
| Movement: | Still, minimal movement, controlled, calculated, sleek, and |
| | precise |
| Scale: | Large features and bones as to length, width, and/or diameter. |
| Texture: | Smooth, stiff, and/or Shiny |
| Yang: | Broad shoulders, tall, stately, large clear-cut features, erect, |
| | and/or bold |
| Personality: | Competent, capable, efficient, aloof, private, intimidating, |
| | sophisticated, disciplined, and/or influential |
| Thought Process: | Left brained, logical, decisive, and/or clear thinking |
| Negative Tendencies: | Uncompromising. |

The saturated attribute can be described with an association to the elements in nature. As such, a saturated natural or man-made setting can be described by the following: stark contrast of a winter landscape (e.g., dark green pine tree against a white snow background); black panthers; sharply defined and contrasting color schemes; repeated lines, such as rows of pine trees, or the pine needles on a branch; the shape of crystal clear icicles; the rows of slender cypress; mirrored still pools; silhouette of the Manhattan sky-line at dusk; the Parthenon crowning the Acropolis; stately Greek columns; gleaming marble; the appearance of a polar bear; undulating, snow covered slopes; a crescent moon; stained glass windows; icebergs; and orchids. Additionally, other things or elements of our environment that are ideologically related to saturated attributes can be described by the following: bold, clear print; Japanese culture and decorations; high fashion; structures with clean lines; the appearance of an eyebrow arching; the image of Jacqueline Onassis; crystals; silver decorations; chrome; glass; and white linens.

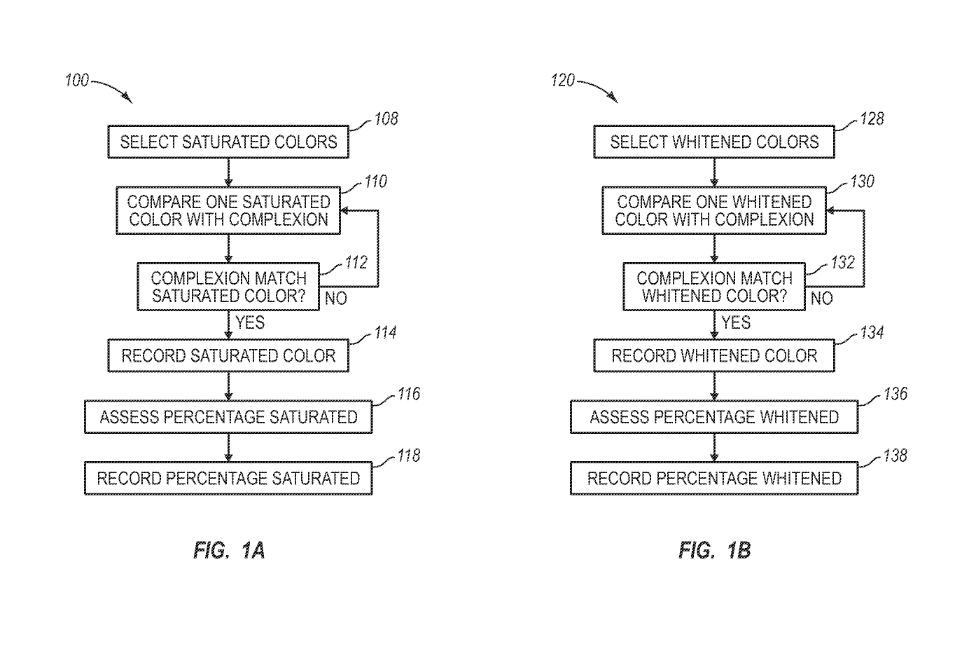

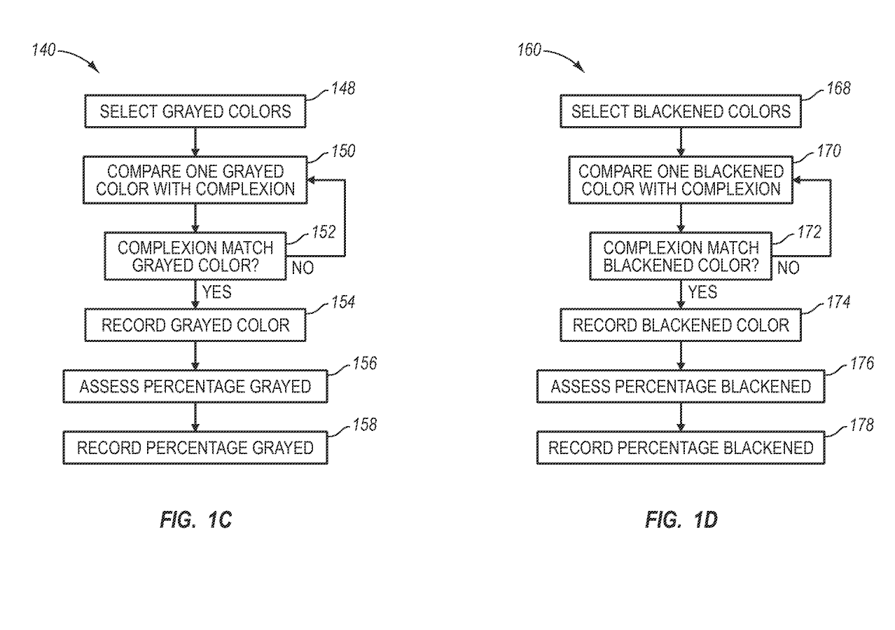

FIG. 1A is a flow diagram illustrating an embodiment of a method for determining whether or not a person has a saturated attribute. Accordingly, a saturation analysis 100 can be performed during a color reading. A color reading can be performed by analyzing colors with the different attributes, and saturation can be assessed by selecting and/or obtaining saturated colors (Block 108). That is, a group of colors with varying saturation can be pulled so that each can be compared to the person. As such, a first color is compared next to the person's complexion (Block 110), which can be performed by holding up a color card next to the person's skin and determining whether or not the color in their skin matches the coloring of the color card (Block 112). In the instance the complexion does not perfectly match the color on the color card, the next card can similarly be compared (Block 110). Also, colors that match the person's complexion can be recorded so that the different colors can be compared later or for some other reason (Block 114). Additionally, the percentage of the person's color that is saturated can be assessed (Block 116), wherein a person's color can be comprised of the different attributes each as a certain percentage. For example, a person's color may be about 75% saturated, 15% grayed, and 10% blackened. Accordingly, the percentage or amount of their color that is saturated can be recorded (Block 118). The percentage of saturation can be compared to the other attributed to determine the person's primary design.

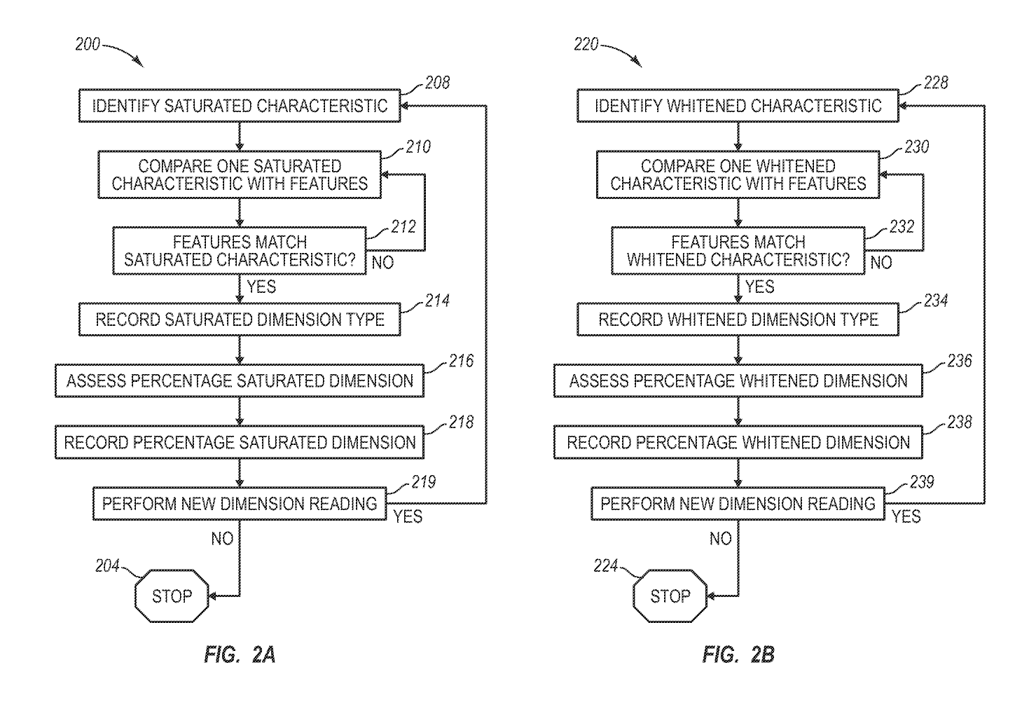

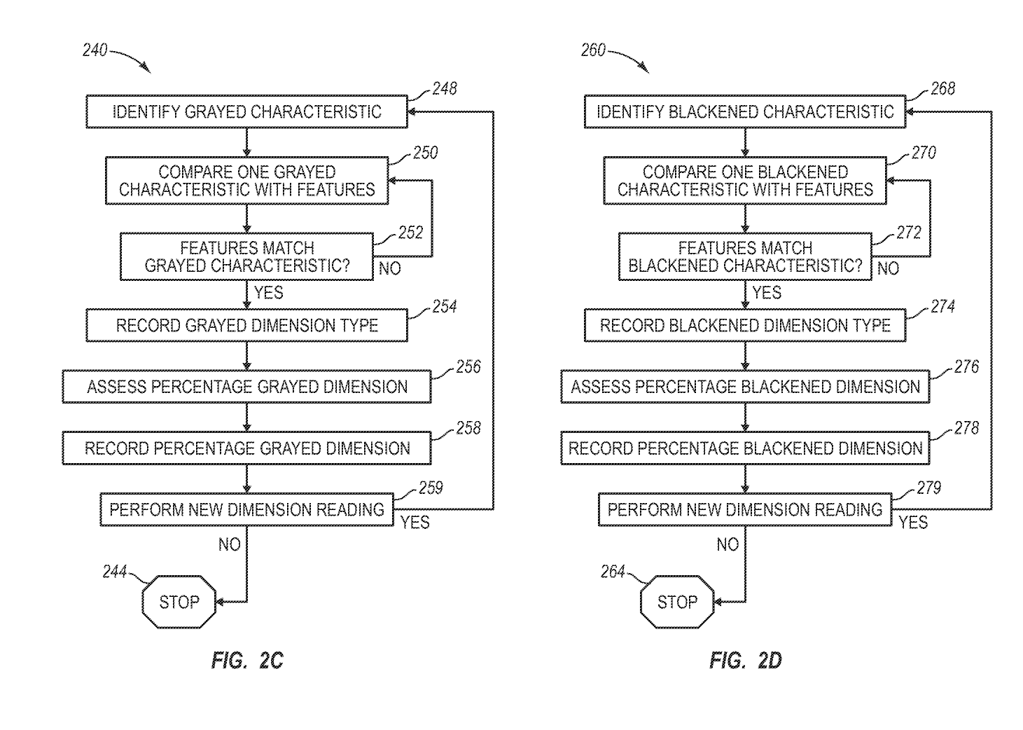

FIG. 2A is a flow diagram illustrating an embodiment of a method for determining whether or not a person has a physical element has a saturated attribute. Such a saturated analysis 200 can be performed with any of the physical elements described herein. The saturated analysis 200 can begin by identifying a saturated element to study and analyze (Block 208). As such, the physical characteristics for the identified element that relate to the saturated attribute can be identified so that their presence can be assessed. Accordingly, one saturated characteristic for the element can be compared to the physical features displayed by the person (Block 210). For example, when the element is lines, the saturated characteristics to be compared with the person's physical features include parallel lines, fast diagonals, and/or ovals. Next, a determination is made as to whether or not the one saturated characteristic is present (Block 212). In the instance the saturated characteristic is present on the person the type is recorded (Block 214), otherwise a new saturated characteristic is analyzed (Block 210). Also, the percentage of the element that is saturated can also be assessed (Block 216), and the percentage of saturation can be recorded (Block 218). A new element can then be assessed for being saturated (Block 208), or the assessment can be stopped (Block 204).

### B. Whitened

The description and possibly the origination of the whitened attributes comes from a color wheel that has tinted colors. All of the colors on the tinted color wheel, which can include each color, such as red, orange, yellow, green, blue, indigo, violet, as well as others, have colors that include some amount of whitening. As such, whitened colors can be obtained by adding white to the colors of a saturated color wheel. This is usually referred to as a tint.

A person that is whitened tends to appear more harmonious or comfortable in the presence of any and/or all the colors on the whitened color wheel, wherein pure colors have been whitened. Often, when a person is whitened, it can become obvious when the colors of a whitened color wheel are presented next their skin because their personal coloring tends to match or harmonize with colors that have some amount whitening. Accordingly, as a whitened person is compared to a grouping of colors, which includes whitened colors, it becomes very clear that their coloring harmonizes preferentially with the whitened colors. Also, this usually corresponds with rounded lines and a crisp and/or decorated texture.

Further analysis of a whitened person can often result in identifying the various lines in their body being predominantly rounded with circles, arcs, and repetition in the roundedness. Their bone structure is usually consistent with the lines of the whitened attributes by presenting roundedness and circles so as to almost appear to be moving even when they are still.

Additionally, when the whitened person sits and/or moves around, there is a lot of superfluous motions and/or a lot of movement. For the most part they are moving even when sitting still. This can be illustrated by a person that is always animated when sitting or walking, or being busy and/or bouncy for extended durations. For example, a when a whitened person sits in a chair, they do not sit very long, and often resort to moving from side to side or changes positions every few minutes, and incessantly talking with their hands.

The central focus for a whitened person is to have fun through understanding and connecting with others. They do not always have to be greeted because they are usually greeting everyone else. This inner happiness can be felt because their presence is similar to sunshine coming into a room. That is, they brighten up a room. Sometimes they can appear to be youthful no matter their actual age. They are alive and often creates enthusiasm and makes things fun.

In summary, the whitened person can be analyzed with the characteristics, both physical and/or personality, as shown in Table 2.

TABLE 2
Whitened

| | |
|---|---|
| Color: | Whitening, tints, and/or warm coloring |
| Line: | Circles, arcs, roundedness, and/or repetition |
| Contrast Value: | Low to medium contrast value |
| Visual Features: | Youthful, natural, animated, inviting, and/or cheerful |
| Sound: | Constantly talking, rapid speech, and/or giggling |
| Movement: | Bouncing, active, busy, can't sit still, animated, and/or a |
| | maximum amount of movement |
| Scale: | Small features and bones as to length, width, and diameter |
| Texture: | Crisp, lightweight, decorated, and/or softness |
| Yin: | Small features, small bones, dainty, fragile, rounded, and/or |
| | petite |
| Personality: | Extraverted, light hearted, spontaneous, bubbly, high energy, |
| | silly, childlike, and/or cute |
| Thought Process: | Takes in information very quickly, spontaneous, non-structured, |
| | non-conforming, unassuming, trusting, and/or comforting |
| Negative tendencies: | Non-Committal |

The whitened attribute can be described with an association to the elements in nature. As such, the whitened natural or man-made setting can be described by the following: rolling hills, aspen, things that appear awakened with the force of life; rose buds opening up for the sun; the expectant faces of children; things that appear radiant with the pulse of living; the impetuous expectancy of a crocus in the snow; white layers of dogwood; blue skies; white clouds; cherry trees in a burst of pink; movement of long grasses in a slow wind; the sound of horse hooves on cobblestone; cherries, apples and pears; living green meadows; painted eggs; the wind teasing a paper down a hill; amusement parks such as the circus, Coney Island, and Disneyland; football; cheering crowds; and parades. Additionally, other things or elements of our environment that are ideologically related to whitened attributes can be described by the following: Doris Day; Mary Tyler Moore; being imbued with energy and strength; things seeking involvement; being stimulating, elastic, exhilarating, and/or buoyant; and/or being leavened with lightness and laughter

FIG. 1B is a flow diagram illustrating an embodiment of a method for determining whether or not a person has a whitened attribute. Accordingly, a whitened analysis 120 can be performed during a color reading. A color reading can be performed by analyzing colors with the different attributes, and the whitened attribute can be assessed by selecting and/or obtaining whitened colors (Block 128). That is, a group of colors with varying whitening can be pulled so that each can be compared to the person. As such, a first whitened color is compared next to the person's complexion (Block 130), which can be performed by holding up a color card next to the person's skin and determining whether or not the color in their skin matches the coloring of the color card (Block 132). In the instance the complexion does not perfectly match the whitened color on the color card, the next card can similarly be compared (Block 130). Also, whitened colors that match or are similar the person's complexion can be recorded so that the different colors can be compared later or for some other reason (Block 134). Additionally, the percentage of the person's color that is whitened can be assessed (Block 136), wherein a person's color can be comprised of the different attributes each at a certain percentage. For example, a person's color may be about 65% whitened and 45% grayed. Accordingly, the percentage or amount of their color that is whitened can be recorded (Block 118). The percentage of being whitened can be compared to the other attributed to determine the person's primary design.

FIG. 2B is a flow diagram illustrating an embodiment of a method for determining whether or not a person has a physical element with a whitened attribute. Such a whitened analysis 220 can be performed with any of the physical elements described herein. The whitened analysis 220 can begin by identifying a whitened element to study and analyze (Block 228). As such, the physical characteristics for the identified element that relate to the whitened attribute can be identified so that their presence can be assessed. Accordingly, one whitened characteristic for the element can be compared to the physical features displayed by the person (Block 230). For example, when the element is sound, the whitened characteristics to be compared with the person's physical features include giggling, rapid speech, and/or constant talking. As such, a determination is made as to whether or not the whitened characteristic is present (Block 232). In the instance the whitened characteristic is present on the person the type is recorded (Block 234), otherwise a new whitened characteristics is analyzed (Block 230). Also, the percentage of the element that is whitened can also be assessed (Block 236), and the percentage that is whitened can be recorded (Block 238). A new element can then be assessed for being whitened (Block 228), or the assessment can be stopped (Block 224).

### C. Grayed

The description and origination of the grayed attributes come from a color wheel that has toned colors. All of the colors on the toned color wheel, which can include each color, such as red, orange, yellow, green, blue, indigo, violet, as well as others, have colors that include some amount of graying. As such, grayed colors can be obtained by adding gray to the colors of a saturated color wheel, which is usually referred to as a tone.

A person that is grayed tends to appear more harmonious or comfortable in the presence of some or all the colors on the grayed color wheel. Often, when a person is grayed, it can become obvious when the colors of a grayed color wheel are presented next to their skin because their personal coloring tends to match or harmonize with colors that have some amount graying. Accordingly, as a grayed person is compared to a grouping of colors, which includes grayed colors, it becomes very clear that their coloring harmonizes preferentially with the grayed colors. Also, this usually corresponds with long curving lines and a matte texture. Often, a grayed person can be visually identified because they tend to have monochromatic skin, features, and hair.

Further analysis of a grayed person can often result in identifying the various lines in their body being predominantly elongated and curved, which can be compared to an elongated “S” curve. Their bone structure is usually consistent with the lines of the grayed attributes by presenting lines that are curved, elongated, and drawn out.

Additionally, when the grayed person sits and/or moves around, they appear to be graceful and flowing so as to exude elegance. Also, their sitting can be viewed as having the shape of an “S” curve, wherein some may see slouching, a more detailed eye can see the gracefulness as they seem to be melting into a chair. Also, they tend to float in their movement.

The central focus for a grayed person is to be appropriate. They can achieve this by studying everything in their presence, which includes analyzing every detail and processing all contingencies. However, this can cause the grayed person to feel overwhelmed because they try to process everything only to have a difficult time making decisions. Their personality can appear to be soft spoken and detail oriented. They will repeatedly process the same information, and try not to leave anything out. Usually, a grayed person does not like to be the center of attention in a crowd. In fact, they prefer to blend into a crowd rather than to be noticeable and stand out.

In summary, the grayed person can be analyzed with the characteristics, both physical and/or personality, as shown in Table 3.

TABLE 3
Grayed

| | |
|---|---|
| Color: | Toned colors and cool coloring |
| Line: | Curved lines, elongated and/or “S” curved body shapes |
| Contrast Value: | Medium contrast value |
| Visual Features: | Dignified, subtle, elegant, mysterious, delicate, refined, and/or |
| | distinctive |
| Sound: | Eloquent, articulate, reserved, minimal, and/or small voice |
| Movement: | Graceful, languid, and/or flowing |
| Scale: | Small, medium, and/or large |
| Texture: | Soft, limp, billowy, sheer, matte, dull, fine, quality, and/or |
| | expensive |
| Yin: | effeminate, refined, and/or elongated |
| Personality: | Introverted, soft spoken, negotiable, empathetic, proper, |
| | meticulous, and/or preference to observe rather than participate |
| Thought Process: | Complex, idealistic, sensitive, worrying, nurturing, artistic, |
| | peacemaker, intuitive, and/or sentimental |
| Negative Tendencies: | Indecisive |

The grayed attribute can be described with an association to the elements in nature. As such, the grayed natural or man-made setting can be described by the following: life under the sea; settings that appear serene, diffused, and/or enchanted; light coming through the forest; a solitary manor appearing through mist; haze; a melancholy wind-swept seashore; a rainbow; tender brown doe eyes; misty otherworldliness of deep dark forests; moss-hung trees; afternoon ponds; landscapes that have varying levels of subtle colors that are grayed, blended, muted, shadowy, and/or interwoven; ink-washed Chinese paintings; a mauve after-glow of a sunset; cool green dusk; impressionist paintings that are pale and soft; an abalone shell; a delicately-colored porcelain figure; an iridescent opal; mother-of-pearl; a full-blown rose; gossamer butterfly wings; sea grass moving in silky undulation; various motions of natural settings that appear to be flowing, cascading, and/or fluid; willows waving in the wind, a gray Maseratti; floating boas of ostrich feathers; a gently winding stream, the gilded opulence of a Louis XV drawing room, settings that appear formal, soignee, and/or soft hats and chiffon scarves.

FIG. 1C is a flow diagram illustrating an embodiment of a method for determining whether or not a person has a grayed attribute. Accordingly, a grayed analysis 140 can be performed during a color reading. A color reading can be performed by analyzing colors with the different attributes, band the grayed attribute can be assessed by selecting and/or obtaining grayed colors (Block 148). That is, a group of colors with varying amounts of graying can be pulled so that each can be compared to the person. As such, a first grayed color is compared next to the person's complexion (Block 150), which can be performed by holding up a grayed color card next to the person's skin and determining whether or not the color in their skin matches the grayed coloring of the color card (Block 152). In the instance the complexion does not perfectly match the grayed color on the color card, the next card can be similarly compared (Block 150). Also, grayed colors that match the person's complexion can be recorded so that the different grayed colors can be compared later or for some other reason (Block 154). Additionally, the percentage of the person's color that is grayed can be assessed (Block 156), wherein a person's color can be comprised of the different attributes each as a certain percentage. For example, a person's color may be about 85% grayed, 10% saturated, and 5% blackened. Accordingly, the percentage or amount of their color that is grayed can be recorded (Block 118). The percentage of grayed can be compared to the other attributed to determine the person's primary design.

FIG. 2C is a flow diagram illustrating an embodiment of a method for determining whether or not a person has a physical element with a grayed attribute. Such a grayed analysis 240 can be performed with any of the physical elements described herein. The grayed analysis 240 can begin by identifying an element to study and analyze for the presence of the grayed attribute (Block 248). As such, the physical characteristics for the identified element that relate to the grayed attribute can be identified so that their presence can be assessed. Accordingly, one grayed characteristic for the element can be compared to the physical features displayed by the person (Block 250). For example, when the element is movement, the grayed characteristics to be compared with the person's physical features include graceful, flowing and/or languid movements or positioning. As such, a determination is made as to whether or not the grayed characteristic is present (Block 252). In the instance the grayed characteristic is present on the person the type is recorded (Block 254), otherwise a new grayed characteristics is analyzed (Block 250). Also, the percentage of the element that is grayed can also be assessed (Block 256), and the percentage that is grayed can be recorded (Block 258). A new element can then be assessed for having a grayed attribute (Block 248), or the assessment can be stopped (Block 244).

### D. Blackened

The description and origination of the blackened attributes come from a color wheel that has shaded colors. All of the colors on the shaded color wheel, which can include each color, such as red, orange, yellow, green, blue, indigo, violet, as well as others, have colors that include some amount of black. As such, blackened colors can be obtained by adding black to the colors of a saturated color wheel, which is usually referred to as shading.

A person that is blackened tends to appear more harmonious or comfortable in the presence of some or all the colors on a shaded color wheel. Often, when a person is blackened, it can become obvious when the colors of a shaded color wheel are presented next their skin because their personal coloring tends to match or harmonize with colors that have some amount black. Accordingly, as a blackened person is compared to a grouping of colors, which includes shaded colors, it becomes very clear that their coloring harmonizes preferentially with the blackened colors. Also, this usually corresponds with hard lines and a rough texture.

Further analysis of a blackened person can often result in identifying the various lines in their body being predominantly hard, angular, and geometrically shaped. As such, their bone structure is usually consistent with the hard lines of the blackened attributes by presenting lines that are orthogonal, and in hard geometric shapes.

Additionally, when the blackened person sits and/or moves around, they appear to be deliberate and purposeful. They tend to have a medium amount of movement, and when they do move it appears to be important.

The central focus for a blackened person is to be task oriented and get the job done. These people are very structured and like to be integrally involved in projects from being a worker to a director as long as they are responsible doing something. A blackened person can be identified by walking purposefully, acting purposefully, and speaking deliberately. This includes being predisposed to be truthful, direct, and telling it like it is. Blackened people often love sports or outdoor activities, and like to be in nature.

In summary, the blackened person can be analyzed with the characteristics, both physical and/or personality, as shown in Table 4.

TABLE 4
Blackened

| | |
|---|---|
| Color: | Shades and darker coloring |
| Line: | Angular or geometric body shapes, vertical lines that form right |
| | angles, orthogonal lines, diagonal lines and/or intersecting lines |
| Contrast Value: | Medium to high contrast value |
| Visual Features: | Bold, rough, defined, physically large, muscular, strong, |
| | powerful, casual, and/or earthy |
| Sound: | Loud, raspy, and/or rough |
| Movement: | Deliberate, purposeful, and/or medium movement |
| Scale: | Large features and bones |
| Texture: | Rough, knobby, natural, thick, matte, and/or dull |
| Yang: | Angular, tough, athletic, and/or sturdy |
| Personality: | Assertive, direct, confident, structured, informal, practical, |
| | efficient, stable, and/or conservative |
| Thought Process: | Task oriented, compartmentalize events, and/or driven |
| Negative Tendencies: | Overbearing |

The blackened attribute can be described with an association to the elements in nature. As such, the blackened natural or man-made settings, as well as various things in our surroundings and environments can be described by the following: plateaus, tigers, earthy colors that are deep and rich; mellowed terracotta; copper bowls and clay vessels; grasses that are dry and woven; tall tree trunks such as great old cedars; heavy-laden sheaves of grain; hand-rubbed leather and tweed; tree bark; pine cones; granite; sandstone; German castles; Stonehenge; Niagara Falls; jagged, rocky mountain peaks; lightening bolts; the force of rushing water; and a charging bull. Additionally, other things or elements of our environment that are ideologically related to saturated attributes can be described by the following: Walt Whitman; objects with sharp, swift lines; things that appear to be dynamic, intense, and/or powerful; the tension of opposing lines; the winds of war; massive metal sculptures; hard geometric designs; Navajo rugs and arrows; a jack-hammer; a lion's mane; and Beethoven.

FIG. 1D is a flow diagram illustrating an embodiment of a method for determining whether or not a person has a blackened attribute. Accordingly, a blackened analysis 160 can be performed during a color reading. A color reading can be performed by analyzing colors with the different attributes, and the blackened attribute can be assessed by selecting and/or obtaining blackened colors (Block 168). That is, a group of colors with varying blackening can be pulled so that each can be compared to the person. As such, a first blackened color is compared next to the person's complexion (Block 170), which can be performed by holding up a color card next to the person's skin and determining whether or not the color in their skin matches the blackened coloring of the color card (Block 172). In the instance the complexion does not perfectly match the blackened color on the color card, the next card can similarly be compared (Block 170). However, even it the blackened color perfectly matches the person's coloring, other color cards can also be similarly compared. Also, the various blackened colors that match the person's complexion can be recorded so that the different colors can be compared later or for some other reason (Block 174). Additionally, the percentage of the person's color that is blackened can be assessed (Block 176), wherein a person's color can be comprised of the different attributes each as a certain percentage. For example, a person's color may be about 50% blackened, 25% grayed, and 25% saturated. Accordingly, the percentage or amount of their color that is saturated can be recorded (Block 118). The percentage of the blackened attribute can be compared to the other attributed to determine the person's primary design.

FIG. 2D is a flow diagram illustrating an embodiment of a method for determining whether or not a person has a physical element with a blackened attribute. Such a blackened analysis 260 can be performed with any of the physical elements described herein. The blackened analysis 260 can begin by identifying an element to study and analyze for the presence of a blackened attribute (Block 268). As such, the physical characteristics for the identified element that relate to the blackened attribute can be identified so that their presence can be assessed. Accordingly, one blackened characteristic for the element can be compared to the physical features displayed by the person (Block 270). For example, when the element is texture, the blackened characteristics to be compared with the person's physical complexion and/or skin include a knobby, thick, dull, and/or rough texture. As such a determination is made as to whether or not the element characteristic is present (Block 272). In the instance the blackened characteristic is present on the person the type is recorded (Block 274), otherwise a new blackened characteristics is analyzed (Block 270). Also, the percentage that is element that is blackened can also be assessed (Block 276), and the percentage of being blackened can be recorded (Block 278). Moreover, a new element can then be assessed for the presence of the blackened attribute (Block 268), or the assessment can be stopped (Block 264).

### IV. Correlating Design Attributes

In addition to identifying an attribute that describes an element, an analysis of a person's personality profile or predisposition can include correlating the attributes for different elements. As such, a predominant attribute can be identified for at least two elements, and the predominant attribute for each element can be compared and correlated. A correlation of the elements can be performed in order to identify a primary attribute that is the same for most attributes, and most preferably for all attributes. That is, when a primary attribute can be determined, the personality profiles and predispositions that relate to that person are identified.

In one embodiment, a method of analyzing a person's personality profile is in accordance with the present invention. Such a method can include analyzing a first element to determine a first primary attribute for the person. As such, the first primary attribute is characterized as being the attribute that is predominant with respect to the first element. As before, the attribute is selected from the group consisting of saturated, whitened, grayed, and blackened. Thus, the primary attribute is the attribute that is most prevalent with respect to the element being analyzed.

Additionally, the method can include analyzing at least a second element to determine at least a second primary attribute for the person. Again, the second primary attribute is characterized as being the attribute that is predominant with respect to the second element. After first and second primary attributes are identified, the first primary attribute and the at least second primary attribute are compared and correlated to obtain a correlated primary attribute. The correlated primary attribute is the attribute that is predominant for both elements. Also, the correlation can be continued for additional elements to make sure that each element can be characterized by the correlated primary attribute, such as being repeated for a third element and so on.

A correlated primary attribute, which is the primary attribute for more than or all of the elements, can be identified because of the harmony principle. The harmony principle is based on the observation that the elements are related and in harmony. That is, most if not all elements for a single person have the same primary attribute, and possible the same secondary attributes. Accordingly, when the primary attribute is identified for one element, it is likely that same attribute is primary for the other elements. Thus, a person that is predominantly saturated in color is also likely to be saturated in lines, movement, and sound.

After the correlated primary attribute is determined, the personality characteristics that are related to the correlated primary attribute can be identified. Accordingly, these personality characteristics that relate to the correlated primary attribute can either be predicted to be present in the person's personality, or they can be earmarked for monitoring. That is, they can be identified so that their presence can be confirmed by monitoring or observing the person. As such, by identifying a primary attribute that is the same for multiple elements, a person's personality profile or predisposition can be predicted.

The primary attribute for any given element can be identified by the methods described herein. Accordingly, when more than one attribute can be used to describe a single element, the attributes can be ranked so that the most predominant attribute can be identified. As such, the process of determining the presence of an attribute for an element can include approximating or quantifying the percentage of that attribute for the element. Also, the attributes that can be used to describe the element can be ranked from most predominant to least predominant. For example, each attribute can be ranked from 1 to 10, wherein the most dominant can be represented by the number “10” and the least dominant can be represented by the number “1.” The ranking can be done for each element that has been analyzed, and then the average ranking can be identified, which is the average primary attribute or correlated primary attribute. On the other hand, each attribute that is present can be ranked with respect to the other attributes. For example, this can result in an identification that saturated ranks highest for most of the elements, which identifies saturated as being the correlated primary attribute. Additionally, various other methods can be used to identify the attribute that is predominant for most, if not all, of the elements.

The foregoing process of identifying the primary attribute for all elements can be extrapolated to identify the secondary, tertiary, and possible quaternary attributes. The secondary, tertiary, and quaternary attributes may or may not be present, or they may be present in small amounts. Also, after a primary attribute is determined it may be difficult to identify the secondary and tertiary elements with respect to one another. As such, a primary attribute can be identified and followed by an analysis of the other attributes that can be observed, and hence identification of at least a secondary attribute. This can result in more than one secondary attribute. Thus, the identification of a primary attribute and any secondary attribute can be part of the analysis that identifies a person's design.

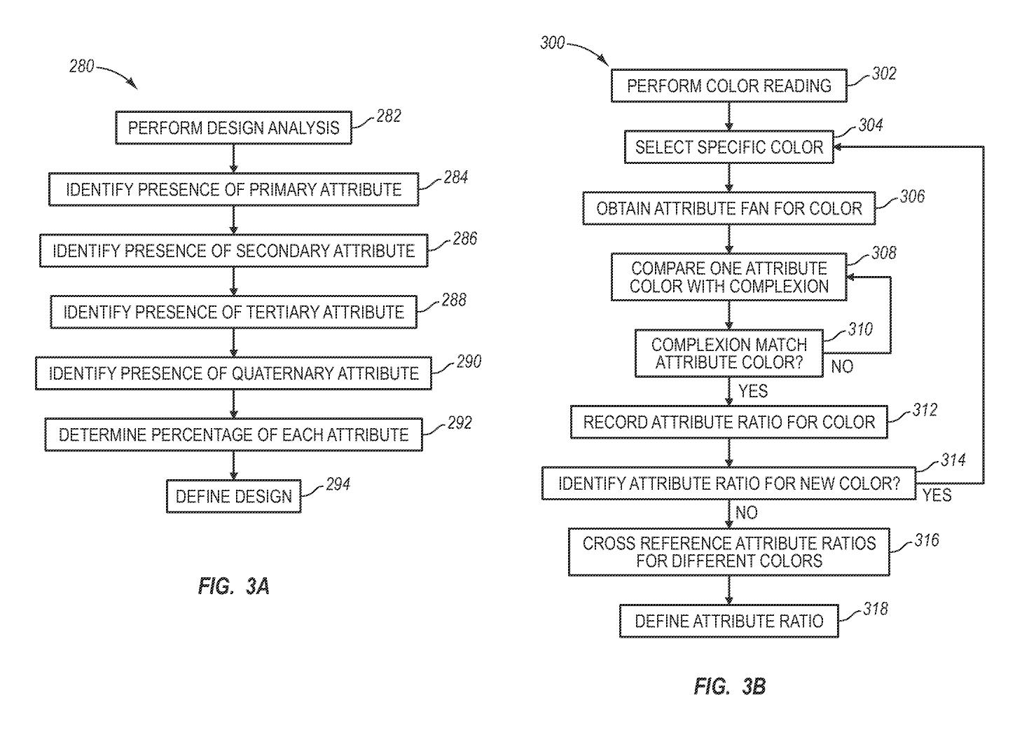

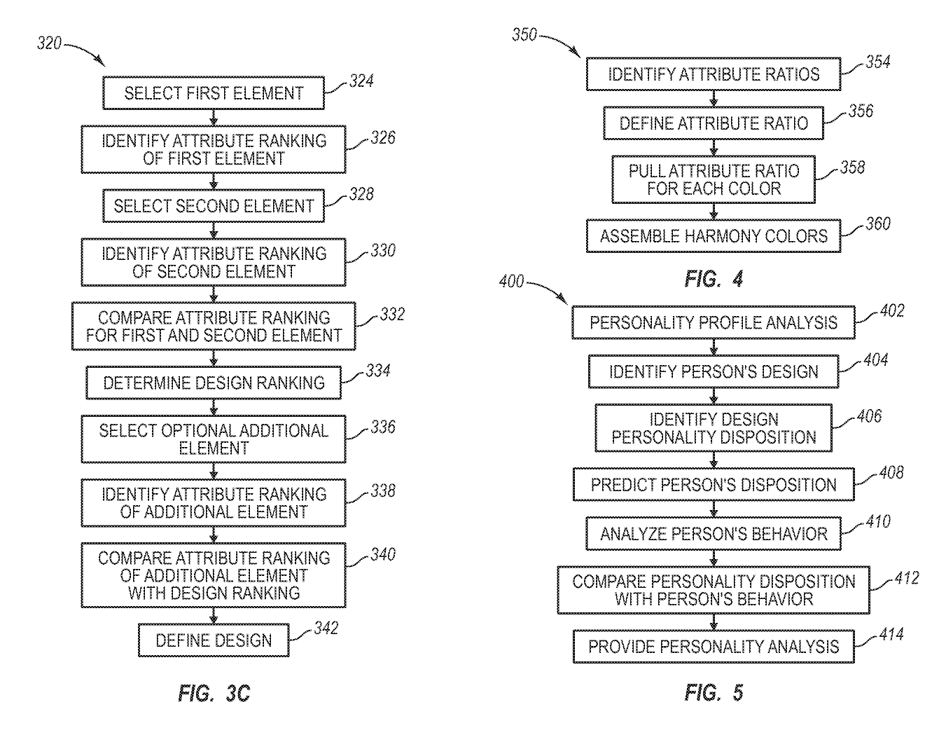

FIG. 3A is a flow diagram illustrating an embodiment of a method for identifying a person's design. A design analysis 280 can be performed by a person's elements being analyzed for the presence of the attributes (Block 282). Accordingly, a primary attribute can be identified for at least one element (Block 284), wherein the primary attribute is preferably the same for each element. A secondary attribute is then identified, if present, for at least one element (Block 286), wherein the secondary attribute is preferably the same for each element. A tertiary attribute is then identified, if present, for at least one element (Block 288), wherein the tertiary attribute is preferably the same for each element. A quaternary attribute is then identified, if present, for at least one element (Block 290), wherein the quaternary attribute is preferably the same for each element.

The attributes can be ranked from most dominant to least dominant, which is accomplished by identifying which attribute is primary, secondary, etc. Additionally, the attributes can be ranked by determining what percentage of the element can be described by each attribute. For example, when about 50% or more of the element fits with the saturated attribute, the primary attribute is considered to be saturated. Similarly, the secondary attributes can be ranked by percentage. In any event, the identification of the primary attribute and any secondary attribute can be considered to determine the person's design. This is because a person's design is described by the ranking of their attributes.

FIG. 3B is a flow diagram illustrating an embodiment of a method 300 for identifying a person's design. The person's design can be identified by performing a color reading (Block 302), which includes selecting a specific color, such as red, blue, green, etc., to be analyzed (Block 304). A color fan for that color is then pulled, wherein the color fan includes the selected color at different levels of being saturated, whitened, grayed, and/or blackened (Block 306). As such, the grades of an individual attribute or multiple attributes for the selected color can be used. A color card having a specific color at a specific attribute ratio, which is described as the amount of the attribute present in the color, is then compared to the person's complexion (Block 308) to determine if the specific attribute ratio matches the person complexion (Block 310). An attribute ratio is described to be the ratio or percentage of each attribute in the color a color card. Optionally, the attribute ratio can be labeled on each color card, or it can be approximated by standards well-known in the art. In the instance the complexion matches or is similar with the attribute ratio on the card the attribute ratio is recorded (Block 312), otherwise another color card having the specific color at a different specific attribute ratio is then compared with the person's complexion (Block 308). This can be repeated for the color cards having different attribute ratios for the same color, and again for another color.

Optionally, the same process is repeated for multiple colors (Block 314). After multiple colors have been compared to the person's complexion, and multiple attribute ratios have been identified, the attribute ratios can be cross referenced between the different colors (Block 316). Accordingly, the attribute ratios can be similar or the same for the different colors. This is because harmony does not exist only between different elements, but different colors will also be harmonious in that attribute ratios will be similar or the same for different colors. As such, the attribute ratio for red that matches the person's complexion can be about the same as the attribute ratio for blue, and so on. Also, when different, the attribute ratios can be averaged to identify the primary attribute ratio. In any event, when the primary or correlated attribute ratio for the person's complexion is identified from the cross referencing, the primary or correlated attribute ratio indicates or defines the person's design.

FIG. 3C is another embodiment of a method for determining a person's design, which can also be considered to be their harmony design. A design analysis 320 can be performed by selecting a first element to be analyzed (Block 324). The first element is then analyzed to determine the attribute ranking or attribute ratio for the first element (Block 326). A second element is then selected (Block 328), and the corresponding attribute ratio for the second element is then identified (Block 330). The first element attribute ranking is then compared to the second element attribute ranking (Block 332), which is then used to determine the design ranking (Block 334). The design ranking is the attribute ranking that describes the design.

Optionally, an additional element is then selected (Block 336), and the corresponding attribute ratio for the additional element is then identified (Block 338). The additional element attribute ranking or ratio is then compared to the design ranking (Block 340). When the first, second, and additional elements have substantially identical or similar attribute rankings, the attribute ranking or ratio defines the design for the person (Block 342). On the other hand, when there is a difference between the attribute rankings or ratios for each element, an average can be made between the rankings to determine the primary attribute and any secondary attribute, which in turn defines the design (Block 342).

FIG. 4 is a flow diagram illustrating an embodiment of a method 350 for compiling a color fan that corresponds with a person's harmony design and/or attribute ratio. Such a method can be initiated by any of the processes described herein for identifying the attribute ratio that best describes the person's elements (Block 354). The attribute ratio(s) can then be used to define a primary or correlated attribute ratio to have a certain amount of each attribute (Block 356). A color card having a color for the attribute ratio is then pulled for each color, such as red, blue, green, etc. (Block 358). The color cards having substantially similar attribute ratios are then assembled or grouped together (Block 360). Such a color fan can be considered to be the design color fan, which can be used by the person in improving their appearance or environment.

### V. Personality Profile

The methods of identifying the primary attributes for each element, as well as the correlated primary attribute that is substantially the same for all elements, can be used to predict or identify a person's personality profile or predisposition. As such a person's personality profile or predisposition can be identified by studying and analyzing their physical features. A person's physical features or elements relate to their personality or predisposition because of harmony. Since people have elements about their physical appearance and personality that are harmonious with one another, determining the primary attributes for the elements can then serve to predict their personality.

FIG. 5 is a flow diagram that illustrates an embodiment of a method for identifying or predicting a person's personality profile or predisposition. As such, a profile analysis 400 can be initiated (Block 402) by identifying the person's design (Block 404) as described herein. This can include identifying their attribute ratio, or design element attributes. The personality profile or predisposition for the person's design can then be identified (Block 406). The identification of their personality profile or predisposition can be made from reviewing the attributes for the different elements of personality style, though process, central focus, and/or negative tendencies, which have been described herein and in the incorporated reference. As such, the person's personality profile or predisposition can be predicted based on their primary attribute or design (Block 408). Thus, a person's personality can be assessed by observing their physical appearance or mannerisms without having to ask any questions or interact with the person.

Optionally, the person's personality or behavior can be observed and/or analyzed (Block 410). Accordingly, the observation or analysis of their actual behavior can be compared and/or correlated with the predicted personality profile or predisposition (Block 412). As such, when the observations correlate with the personality predisposition, the harmony between physical features and personality can be confirmed. The personality analysis can then be provided (Block 414) because it is harmonious with the physical features.

### VI. Personality Color

Often, people cannot understand why certain colors do not look good on them. Even though they understand style, they cannot find the proper colors that match their personality profile. As such, an embodiment of the present invention can be employed to find a person's personality color. The personality color is the specific color having an attribute ratio that stands out or projects the most from the person's skin or complexion. Additionally, the attribute ratio for the personality color corresponds with their design, by having the appropriate amount of saturation, whitening, graying, and/or blackening. As such, the foregoing color fan that has the color cards with substantially the same attribute ratios can be used to determine the color, such as red, green, blue, etc., which projects the most from that person's complexion. Thus, the colors having substantially the same attribute ratio can then be used to determine which of those colors is the person's personality color. Additionally, the color that least projects can be considered to be their neutral color.

Accordingly, once a color fan has been established that illustrates a person's design, the best color of the person's design colors is identified. The colors having substantially the same attribute ratio are then ranked in order of best projecting color to least projecting color by holding them up to the person's skin. For example, a subject can have a primary saturated attribute and secondary grayed attribute in their design harmony. This makes the subject very serious and wise. However, when the subject's personality color is identified from their design harmony, their first personality color is yellow. It is a saturated and grayed yellow so it still is true to their inherent harmonious qualities, but it makes them sometimes break out into playfulness, which is associated with the yellow personality color. As such, they can be identified to need to be liberated when things get too regimented.

The personality colors each have unique qualities associated with them. For example, the blue personality color can be described as introverted, cool emotions and feelings, intangible, alert to distinctions, serious, quietness of spirit, and loves change, progress, and the unknown. A person with a violet personality color can be described as merciful, justice, dignity, noble, proud, compassionate, and accomplishment for others. A person with a white personality color can be described as authoritative, light, bright, clean, spiritual, and credible. A person with a black personality can be described as serious, somber, authoritative, intimidating, precise, sophisticated, and visually dominant. A person with a gray personality color can be described as serene, private, subtle, picturesque, dreamy, expensive, idealistic, indecisive, matte, and limp. A person with a green personality color can be described as logical, compassionate, balanced, harmonious, self-respecting, organized; nurturing, efficient, and trustworthy. A person with a red personality color can be described as autonomous, larger muscles, active, self-directing, exciting, impulsive, and a good leader. A person with a fuchsia personality color can be described as peaceful, calming, stimulating, visually exciting, soft, and/or independent. A person with a pink personality color can be described as pampered, not forceful, warm, smaller muscles, low endurance, hesitates, sensual, soft, and a follower. A person with a yellow personality color can be described as lively, easy, radiant, stimulating, liberating, spontaneous, optimistic, and having a zest for life. A person with an orange personality color can be described as considerate, uninhibited, reasonable in actions, persuasive, rhythmic, good timing, energetic, and often victorious. A person with a peach or baby orange personality color can be described as light, warm, sensuous, sexy, charming, dependent, delicate, and a subliminal leader. A person with a brown personality color can have qualities such as being wise, secure, broad spectrum, protective, sturdy, core, wise, stalwart, rich, and strong. A person with a gold personality color can have qualities such as being practical, law abiding, serving, parental, hard working, optimistic, and traditional.

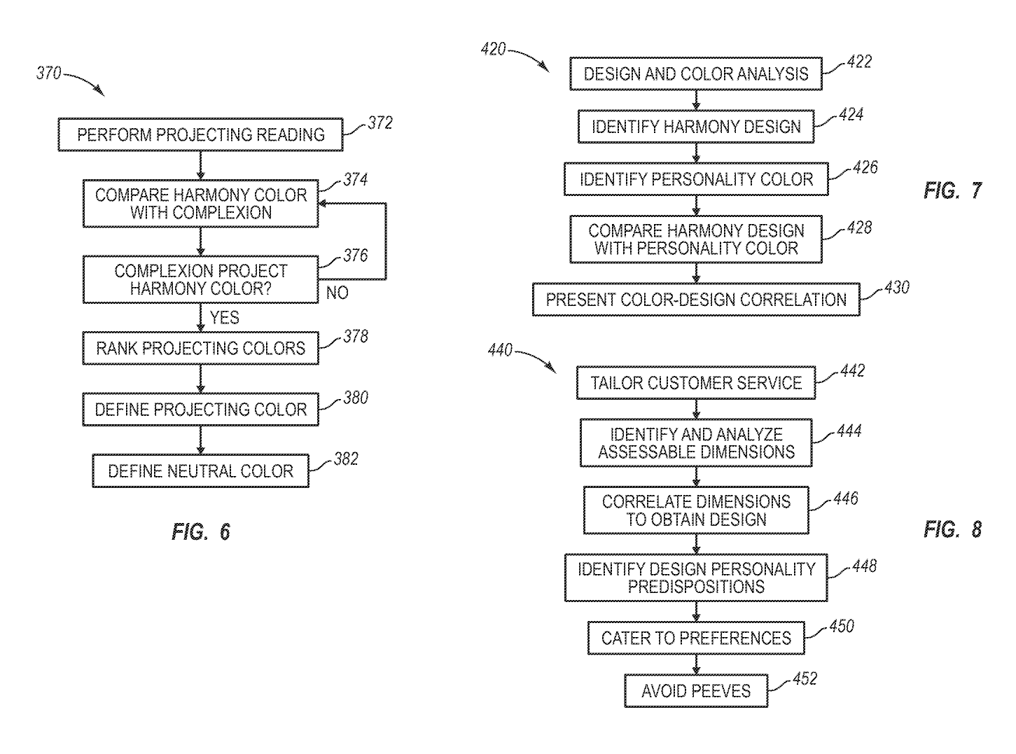

FIG. 6 is a flow diagram illustrating a method for identifying a person's personality color and/or neutral color. A personality color analysis 370 can be done by initiating a projecting color reading (Block 372). As such, each harmony color in the design color fan, which has the attribute ratio, is compared to the person's skin or complexion (Block 374). A determination is made as to whether or not the color having the attribute ratio projects from the person's complexion (Block 376). In the instance the color does not substantially project from their complexion, the next color having substantially the same attribute ratio is compared (Block 374). In the instance the color does substantially project from their complexion is set aside or grouped with other projecting colors. The projecting colors are then ranked from most projecting to least projecting (Block 378). The most projecting color defines the personality color (Block 380). The least projecting color defines the neutral color (Block 382).

FIG. 7 is a flow diagram illustrating an embodiment of a method for identifying a personality profile or predisposition. Such a method can be a design-personality color analysis 420, which can be used to predict a person's personality profile by comparing their design or attribute ratio with their personality color. This can be used to provide the person with insight as to how they act, or enable someone to better understand that person. Accordingly, the method can include identifying the person's design or attribute ratio (Block 424), which can be done as described herein. Also, the method can include identifying the person's personality color (Block 426), which can be done as described herein. The person's design is then compared to their personality color (Block 428) so that the interactions of their design personality profile or predispositions can be correlated with the personality color profile or predispositions. After the comparison is performed, the results, which can include a description that correlates the design and personality color, can then be presented (Block 430) to the person being analyzed or someone else.

### VII. Customer Service by Design

The benefits of being able to identify or predict a person's personality profile or predispositions can be beneficial to those who work in customer service. This is because the server can quickly assess the observable elements to determine the primary attribute, which relates to a series of harmonious personality tendencies or predispositions. Accordingly, the server can tailor their interactions with the person in order to improve the interaction and avoid anything that may bring about the person's negative tendencies.

FIG. 8 is a flow diagram that illustrates a method 440 of improving or performing customer service. The method 440 can be initiated by determining whether or not tailored customer service is needed or beneficial (Block 442). The server then identifies and analyzes the assessable elements in order to determine a primary attribute for at least one element (Block 444). The primary attributes for the assessable elements are then correlated so that a correlated primary attribute can be obtained (Block 446). The personality predispositions for the correlated primary attribute are then identified, which can include the personality style, though process, central focus, and/or negative tendencies (Block 448). The server can then cater to the positive preferences that are conducive to the personality style, though process, and/or central focus (Block 450). The server can then avoid the peeves the person may have, which can be referenced under the negative tendencies. By tailoring customer service, both the server and the person being served can have a more enjoyable experience.

### VIII. Improving Aesthetics by Design

In addition to being able to predict a person's personality profile or predisposition by observing and analyzing their physical elements, the primary attribute or attribute ratio (i.e., harmony design) can also be used to improve a their aesthetics. Accordingly, a person's design or primary attribute can be used in selecting closes, makeup, hair color, clothes, jewelry, shoes, or fashionable accessories. Also, the design or primary attribute can be used in decorating the person's environment, such as their home, office, car, and the like, so that it is more harmonious with their appearance and personality profile.

Accordingly, an embodiment of the present invention includes a method of improving the person's aesthetics, which can use a person's harmony design, primary attribute, or attribute ratio. The method can include presenting a color fan that is comprised of a plurality of colors corresponding to the personality design to the person. That is, the colors can be characterized by the primary attribute or attribute ratio. Additionally, the person can be instructed to include at least one color in the plurality of colors into their appearance, wherein the at least one color is characterize by the primary attribute or the attribute ratio. The color can be used in makeup, hair color, clothes, jewelry, shoes, or fashionable accessories.

Additionally, the person can be instructed to utilize the personality color to present a memorable aesthetic. As such, the personality color can be used for anything previously described in relation to the primary attribute or attribute ratio. Since the personality color still retains the person's design or attribute ratio, use of the personality color is in conformance with enhancing their appearance. Also, when the person does not want to display a memorable appearance, they can be instructed to utilize the least projecting colors.

In addition to using colors, lines that correspond with their primary attribute or attribute ratio can be used to enhance a person's aesthetics. Accordingly, after lines that correspond with the personality design have been identified, they can be used in any aspect of appearance or environment as discussed with respect to color. Also, the person can be instructed to use the lines to present a harmonious aesthetic appearance, especially when they need help improving their appearance.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of analyzing a person's personality profile, the method comprising:
analyzing a first element to determine a first primary attribute for the person, wherein the first primary attribute is characterized as being an attribute that is predominant with respect to the first element, the attribute being selected from the group consisting of saturated, whitened, grayed, and blackened;
analyzing at least a second element to determine at least a second primary attribute for the person, wherein the at least second primary attribute is characterized as being the attribute that is predominant with respect to the second element;
correlating the first primary attribute with the at least second primary attribute to obtain a correlated primary attribute; and
identifying personality characteristics related to the correlated primary attribute.

2. A method as in claim 1, wherein each element is at least one of a color, lines, sound, movement, or texture, and wherein analyzing each element is characterized by the attribute with the following:
a saturated color is a pure chroma;
a whitened color is a tinted chroma;
a grayed color is a toned chroma;
a blackened color is a shaded chroma;
a saturated line includes an oval, parallel lines, or fast diagonal line;
a whitened line includes a circle, portion of circle, or repeating line;
a grayed line includes elongated S-curves;
a blackened line includes angles, right angles, or geometric shapes;
a saturated sound includes authoritative, articulate, or stately speech;
a whitened sound includes giggling, rapid, or constant speech;
a grayed sound includes quite, eloquent, reserved, or minimal speech;
a blackened sound includes loud, raspy, or rough speech;
a saturated movement includes still, controlled, sleek, or precise movements;
a whitened movement includes animated, busy, bouncing, or maximum movements;
a grayed movement includes graceful, flowing, or languid movements;
a blackened movement includes deliberate or purposeful movements;
a saturated texture includes an appearance of being smooth, stiff, or shiny
a whitened texture includes an appearance of being soft, crisp, or decorated;
a grayed texture includes an appearance of being limp, billowy, sheer, or matte; and
a blackened texture includes an appearance of being knobby, thick, dull, or rough.

3. A method as in claim 3, optionally, further comprising:
analyzing at least a third element to determine at least a third primary attribute, the at least third primary attribute is characterized as being the attribute that is predominant with respect to the at least third element, wherein the at least third element is at least one of a color, lines, sound, movement, texture, value contrast, visual attributes, or scale of features, and wherein analyzing the at least third element is further characterized by the attribute with the following:
a saturated value has highest contrast;
a whitened value has medium contrast;
a grayed value has low contrast;
a blackened value has high contrast;
a saturated visual attribute includes striking, sculptured, serious, or polished attributes;
a whitened visual attribute includes youthful, animated, cheerful, or inviting attributes;
a grayed visual attribute includes elegant, delicate, refined, or soft attributes;
a blackened visual attribute includes rustic, bold, earthy, rugged, or tough attributes;
a saturated and blackened scale includes large features;
a whitened scale includes small features; or
a grayed scale includes medium features;
correlating the at least third primary harmony with the correlated primary harmony; and
confirming personality characteristics related to the correlated primary harmony,

4. A method as in claim 3, wherein the identified personality characteristics can be at least one of personality style, thought process, negative tendencies, or central focus, and wherein the identified personality characteristics are characterized by the following:
a saturated personality style includes being introverted, competent, precise, influential, or sophisticated;
a whitened personality style includes being extraverted, social, spontaneous, or silly,
a grayed personality style includes being introverted, proper, meticulous, or negotiable;
a blackened personality style includes being extroverted, direct, practical, informal, or assertive;
a saturated thought process includes being left-brained, logical, decisive, or clear thinker;
a whitened thought process includes being non-structured, spontaneous, or unassuming;
a grayed thought process includes being intuitive, sensitive, complex, or idealistic;
a blackened thought process includes being task oriented, or structured;
a blackened negative tendency includes being intimidating, perfectionist, aloof, or demanding;
a whitened negative tendency includes being annoying, non-committal, intrusive, or inconsiderate;
a grayed negative tendency includes being indecisive, or non-committal;
a blackened negative tendency includes being abrupt, insensitive, overbearing, overly-logical, overly-helpful;
a blackened central focus includes being precise or competent;
a whitened central focus includes being social or entertained;
a grayed central focus includes being knowledgeable or enjoyable; or
a blackened central focus includes being task-oriented.

5. A method as in claim 4, further comprising:
analyzing the first element to determine at least a first non-primary attribute for the person, wherein the at least first non-primary attribute is characterized as being present but not dominant with respect to the first element;
analyzing the at least second element to determine at least a second non-primary attribute for the person, wherein the at least second non-primary attribute is characterized as being present but not dominant with respect to the second element;
correlating the at least first non-primary attribute with the at least second non-primary attribute to obtain at least one correlated non-primary attribute;
identifying personality characteristics related to the correlated secondary attribute; and
ranking the at least one correlated non-primary attribute with the correlated personality attribute, wherein ranking the attributes results in a design.

6. A method as in claim 5, further comprising:
identifying an attribute ratio corresponding to the design;
obtaining a plurality of design colors, each design color being characterized as exhibiting the attribute ratio; and
assembling a design fan comprised of the plurality of design colors.

7. A method as in claim 6, further comprising:
comparing each design color in the design fan with the person's completion;
ranking the design colors from most neutral to most projecting; and
defining a personality color as being the most projecting design color.

8. A method as in claim 7, further comprising;
identifying interpersonal characteristics related to the personality color; and
comparing the identified interpersonal characteristics with the identified personality characteristics to obtain a correlation between the design and the personality color for the person.

9. A method as in claim 8, wherein identifying the interpersonal characteristics is characterized by the following:
a blue personality color includes at least one interpersonal characteristic selected from the group comprised of introverted, cool emotions, intangible feelings, alert to distinctions, serious, quiet spirit, changing, and progressing;
a violet personality color includes at least one interpersonal characteristic selected from the group comprised of merciful, justice, dignity, noble, proud, compassionate, and helpful;
a white personality color includes at least one interpersonal characteristic selected from the group comprised of authoritative, light, bright, cleanliness, spiritual, and credible;
a black personality color includes at least one interpersonal characteristic selected from the group comprised of quality, serious, somber, authoritative, intimidating, precise, sophisticated, and dominant;
a gray personality color includes at least one interpersonal characteristic selected from the group comprised of serene, private, subtle, dreamy, expensive, idealistic, and indecisive;
a green personality color includes at least one interpersonal characteristic selected from the group comprised of logical, compassion, balanced, harmonious, self-respecting, organization, nurturing, efficient, and trustworthy;
a red personality color includes at least one interpersonal characteristic selected from the group comprised of dominant, autonomous, active, self-determinative, exciting, impulsive, and leading;
a fuchsia personality color includes at least one interpersonal characteristic selected from the group comprised of peaceful, calming, stimulating, visually exciting, and independent;
a pink personality color includes at least one interpersonal characteristic selected from the group comprised of pampered, not forceful, warm, low endurance, hesitative, sensual, follower, and reserved;
a yellow personality color includes at least one interpersonal characteristic selected from the group comprised of lively, easygoing, radiant, stimulating, liberating; spontaneous, optimistic, and zestful;
an orange personality color includes at least one interpersonal characteristic selected from the group comprised of considerate, uninhibited, reasonable, persuasive, predictive, energetic, and victorious;
a peach personality color includes at least one interpersonal characteristic selected from the group comprised of warmness, sensuous, sexy, charming, dependent, delicate, and subliminal leadership;
a brown personality color includes at least one interpersonal characteristic selected from the group comprised of wise, security, broad, protective, sturdy, stalwart, and strength; and
a gold personality color includes at least one interpersonal characteristic selected from the group comprised of practical, rule-abiding, serving, parental, hard-working, forward-thinking, and traditional.

10. A method of tailoring interpersonal interactions with the person using the method of analyzing the person's personality profile as in claim 4, further comprising:
catering to a positive identified personality characteristic, the positive identified personality characteristic being at least one of personality style, thought process, or central focus; and
avoiding negative identified personality characteristics, the negative identified personality characteristic being negative tendencies.

11. A method as in claim 10, wherein catering to a positive identified personality characteristic includes interacting with the person so as to induce such positive characteristics, and avoiding negative identified personality characteristics includes interacting with the person so as to inhibit such negative characteristics.

12. A method of analyzing a person's personality profile, the method comprising:
selecting a first element and second element of a person to analyze with respect to having at least one attribute selected from the group comprised of saturated, whitened, grayed, or blackened, the element being selected from the group comprised of color, lines, movement, and sound;
analyzing the first element and second element for the presence of the at least one attribute;
determining a primary attribute that is the same for the first element and second element; and
identifying a primary personality predisposition that corresponds with the primary attribute.

13. A method as in claim 12, further comprising:
determining at least one of a secondary, tertiary, or quaternary attribute to be the same for the first element and second element; and
identifying at least one of a secondary, tertiary, or quaternary personality predisposition that corresponds with the at least one of a secondary, tertiary, or quaternary attribute.

14. A method as in claim 13, further comprising:
determining a percentage for each attribute with respect to the first element and second element, wherein the percentage for each attribute is about the same for the first element and second element; and
identifying a personality design that corresponds with the percentages of each attribute.

15. A method as in claim 14, further comprising:
obtaining a color fan that is comprised of a plurality of colors corresponding to the personality design;
comparing each color in the plurality of colors with the complexion of the person;
ranking each color in the plurality of colors from a least projection color to a most projecting color; and
identifying a personality color to be the most projecting color.

16. A method as in claim 15, further comprising:
identifying an interpersonal characteristic that correlates with the personality color; and
comparing the interpersonal characteristic with at least one of the primary personality predisposition, secondary personality predisposition, tertiary personality predisposition, or quaternary personality predisposition.

17. A method as in claim 16, further comprising:
explaining the interpersonal characteristic to the person;
explaining at least one of the primary personality predisposition, secondary personality predisposition, tertiary personality predisposition, or quaternary personality predisposition to the person; and
counseling the person with respect to the comparison of the interpersonal characteristic with at least one of the primary personality predisposition, secondary personality predisposition, tertiary personality predisposition, or quaternary personality predisposition.

18. A method of improving the person's aesthetics by using the method of analyzing a person's personality profile as in claim 15, the method comprising:
presenting the color fan that is comprised of a plurality of colors corresponding to the personality design to the person; and
instructing the person to include at least one color in the plurality of colors into their appearance, wherein the at least one color can be in makeup, hair color, clothes, jewelry, shoes, or fashionable accessories.

19. A method as in claim 18, further comprising:
instructing the person to utilize the personality color to present a memorable aesthetic; and
instructing the person to utilize the least projecting colors to present a non-memorable aesthetic.

20. A method of improving the person's aesthetics by using the method of analyzing a person's personality profile as in claim 15, the method comprising:
identifying lines that correspond with the personality design;
instructing the person to use the lines to present a harmonious aesthetic appearance, the lines being used in at least one of hair style, eye brows, clothes, shoes, jewelry, or fashionable accessories.

21. A method of analyzing a person's personality profile, the method comprising:
analyzing a color element and a lines element for the presence of at least one attribute selected from the group comprised of saturated, whitened, grayed, or blackened;
determining a primary attribute for the color element and lines element, wherein the primary attribute is the most predominant attribute for both the color element and the lines element; and
identifying a primary personality predisposition that corresponds with the primary attribute.
